(19) United States
(12) Patent Application Publication
(10) Pub. No.: US 2019/0392487 A1
(43) Pub. Date: Dec. 26, 2019

(54) System, Device, and Method of Automatic Construction of Digital Advertisements

(71) Applicant: Intelligent Creative Technology Ltd., Karnei Shomron (IL)

(72) Inventor: Steven Murray Duke, Karnei Shomron (IL)

(21) Appl. No.: 16/381,002

(22) Filed: Apr. 11, 2019

Related U.S. Application Data
(60) Provisional application No. 62/689,180, filed on Jun. 24, 2018.

(51) Int. Cl. G06Q 30/02; G06F 16/35; G06N 3/04; G06N 3/08; G06K 9/00

(52) U.S. Cl. CPC G06Q 30/0276; G06F 16/355; G06K 2209/01; G06N 3/08; G06K 9/00442; G06N 3/04

(57) ABSTRACT

System, device, and method of automatic construction of digital advertisements. An Artificial Intelligence (AI) unit is configured to receive as input: digital copies of past advertisements, and data of their performance results; as well as brand guidelines and a creative brief for automatic generation of a new advertisement. The AI unit generates a set of advertisement elements, such as logo, headline, a sub-headline, call-to-action, legal content, and an image; based on analysis of the input and detection that these particular advertisement elements correspond to previous performance results that are beyond a pre-defined threshold. An automatic advertisement generation unit generates a new advertisement by digitally placing the set of advertisement elements onto a canvas. Optionally, the system automatically generates on-the-fly in real-time a user-tailored advertisement, that is based on analysis of past performance of advertisements that were shown by the same advertiser to this particular end-user.

### CROSS-REFERENCE TO RELATED APPLICATIONS

This patent application claims benefit and priority from U.S. 62/689,180, filed on Jun. 24, 2018, which is hereby incorporated by reference in its entirety.

### FIELD

Some embodiments relate to the field of information technology.

### BACKGROUND

Millions of people worldwide utilize electronic devices for various purposes on a daily basis. For example, people utilize a laptop computer, a desktop computer, a smartphone, a tablet, and other electronic devices, in order to send and receive electronic mail (e-mail), to browse the Internet, to play games, to consume audio/video and digital content, to engage in Instant Messaging (IM) and video conferences, to perform online banking transactions and online shopping, and to do various other tasks.

Some digital content that users watch, read or consume, may include advertisements, such as banner ads which are displayed within (or next to) a text of an online magazine article, or product information or content on the web-site that the user is browsing.

### SUMMARY

The present invention provides systems, devices, and methods of automatic, data-driven construction and autonomous, virtually-infinite continuous evolution of digital advertisements. For example, an Artificial Intelligence (AI) unit is configured to receive as input: digital copies of past advertisements, and data of their performance results; as well as brand guidelines and a creative brief for automatic generation of a new advertisement. The AI unit generates a set of advertisement elements, such as logo, headline, a sub-headline, call-to-action, legal content, and an image; based on analysis of the input and detection that these particular advertisement elements correspond to previous performance results that are beyond a pre-defined threshold; and by using Machine Learning (ML) models as well as feature vectors extracted from an inputted Creative Brief, and by further applying a set of Brand Guidelines or other rules or constraints. An automatic advertisement generation unit generates a new advertisement by digitally placing the set of advertisement elements onto a canvas. Optionally, the system automatically generates on-the-fly in real-time a user-tailored advertisement, that is based on analysis of past performance of advertisements that were shown by the same advertiser to this particular end-user. Then, based on the performance data from that advertisement, and/or based on data relating to the responder or the end-user and his reaction or response to the advertisement, the AI engine of the system adapts and further changes the creative elements to evolve the creative (the advertisement) to be more effective, and/or to generate the next iteration of brand-new advertisements for the same product (or service) or later for a different product or service, in an autonomous self-learning manner. In contrast with conventional A/B testing of advertisements, and conventional digital creative optimization (DCO) systems which merely provide some basic optimization of already-created advertisements, and allow a system to detect which already-generated advertisement version performs better and which already-generated similar advertisement version performs poorer, the system of the present invention takes the Ad Generation process to an entirely different level, and is able to autonomously generate never-before-seen advertisements with (in some scenarios) never-before-combined ad elements; not merely as an A/B testing for optimizing or for selecting between multiple versions of the same advertisement, but rather, for autonomously and automatically generating a brand-new creative (advertisement) based on a Creative Brief and Brand Guidelines, based on AI or ML or NN analysis of past performance of previous advertisements, and further providing an iterative process for further generating new advertisements based on automatically-generated ads and their own performance.

### BRIEF DESCRIPTION OF THE DRAWINGS

FIG. 1 is a block diagram illustration demonstrating an automated method of generating digital advertisements, in accordance with some embodiments of the present invention.

FIG. 2 is a schematic illustration of a system for automatic construction of advertisements, in accordance with some demonstrative embodiments of the present invention.

FIG. 3 is a schematic illustration of a set of some inputs and outputs which may be utilized and/or generated in conjunction with automatic construction of advertisements, in accordance with some demonstrative embodiments of the present invention.

FIG. 4 is a schematic illustration of a set of some client-related inputs and outputs. which may be utilized and/or generated in conjunction with automatic construction of advertisements, in accordance with some demonstrative embodiments of the present invention.

FIG. 5 is a schematic illustration demonstrating an automatic ad creation process, in accordance with some demonstrative embodiments of the present invention.

FIG. 6 is a schematic illustration demonstrating an automatically-generated creative or advertisement, in accordance with some demonstrative embodiments of the present invention.

### DETAILED DESCRIPTION OF SOME DEMONSTRATIVE EMBODIMENTS OF THE PRESENT INVENTION

The terms “advertisement” or “ad” or “digital advertisement” or “digital ad”, as used herein, may comprise any suitable type of content or digital content; for example, represented as or comprising text, graphics, animation, Flash based animation, animation or content that is implemented using HTML or HTML5 or CSS or JavaScript or Java or other suitable technologies, images, photos, illustrations, drawings, vector graphics, bitmap graphics, “emoji” items or icons, audio, video, audio-and-video, sound effects, GUI effects (e.g., hover effects, on-mouse-over effects), or any suitable combination thereof; and particularly, content item(s) that advertise or promote one or more goods or services or brands, or a digital audio/visual form of marketing communication; including “new media” advertisements, banner advertisements or banner ads, mobile or mobile-friendly advertisements (e.g., particularly suitable or tailored to display and/or playback adequately on a mobile electronic device, such as smartphone, tablet, smart-watch); digital ads that are particularly tailored or suitable for incorporation into (or display within) a social network or a social networking website or application, or any digital medium or venue or destination or apparatus which is structured and/or designed for display of content or for publishing of content such as in-store digital displays or digital outdoor display screens, or the like. The output may also be supplied to a printer or sent electronically to a print mechanism, to create physical signage such as promotional posters, window clings and other in-store displays. Accordingly, although portions of the discussion herein may relate, for demonstrative purposes, to automatic generation of digital/on-screen advertisements, the system and method of the present invention may further be utilized in order to automatically generate new Print advertisements or new ad content that is implemented as or embodied in a tangible item (e.g., a printed brochure; a window cling; a promotional poster; an in-store printed poster; signs or signage items; and in some embodiments, even various promotional items such as a promotional shirt or cup or mug or pen or other such item or article.

The term “electronic device” as used herein may comprise any suitable type of device able to display, present, play-back, or otherwise facilitate the consumption of content or digital content and/or of a digital advertisement which may be included to or added to (or other accompany) such digital content; for example, a desktop computer, a laptop computer, a smartphone, a cellular phone, a tablet, a smart-watch, a fitness tracking device, a navigation device, a mapping device, a gaming device or gaming console, a mobile electronic device, a non-mobile electronic device, a vehicular device, a vehicular audio/video system, a vehicular entertainment system, a television, a smart television or smart TV, a screen, a monitor, an electronic reader device or E-reader device or electronic book device or E-book reading device (e.g., a mobile electronic device designed primarily for reading digital e-books and/or periodicals), a Digital Video Recorder (DVR) and/or associated accessories, a cable box or set-top box, and/or any digital medium or electronic apparatus that is structured and/or designed for display of content such as in-store digital displays or digital outdoor display screens, and/or other suitable devices or systems.

The Applicants have realized that advertising agencies, copywriters, graphic designers, illustrators, and other professionals, utilize a significant amount of manual labor and human labor to create from scratch a digital advertisement for a client. The Applicants have realized that a team of professionals that are tasked with creating a new advertisement, often spend dozens of hours of manual work in order to produce a single advertisement.

The Applicants have also realized that a computerized system may be devised in order to automatically or semi-automatically generate digital advertisements for a particular client, or with regard to a particular product or service; based on automatic collection of previously-produced materials, automatic analysis of such materials, automatic extraction of ad-component(s) from such materials, automatic classification of such extracted ad-components, and any performance, targeting and response data associated with the components (or with some of them, or with one of them), automatic selection and arranging (or organizing) of one or more ad-components based on pre-defined ad constructions rules or criteria, and/or automatic generation of a final digital ad based on such operations.

In accordance with a demonstrative embodiment of the present invention, for example, an automatic ad generation system may operate to generate one or more new ads for a client. For example, a Search Module operates to search for previous ads of that client; or in some embodiments, the client may provide an already-prepared historical set of their advertising work along with any related performance data or performance metrics; or such data may be fetched or downloaded or obtained or read from a repository or data silo or a cloud-based silo of the client itself and/or of an advertising network and/or of a third-party provider of online advertisement platform. An Image Analysis Module performs image recognition or computer vision to extract ad-components from each such previous ad. A Classifier Unit performs classification of each ad component (e.g., “logo” or “legalese” or “product image” or “creative text”), and stores the components in an Ad Components Database with indications of their relevant classification features. Client-Specific Rules (or, field-specific rules) define Rules or Constraints or Requirements for ads per client (or, per field; e.g., client brand/logo usage rules, etc.). An Ad Generator Module generates one or more proposed ads for that client (or, for that product or service), by selecting one or more ad components from the database, and applying the rules, and optionally by incorporating digital content that injects a fresh proposal or promotion into the digital ad (e.g., a new particular offering); optionally utilizing also a Selector Module for automatic selection of ad components from the database, and/or an Organizer Module that organizes or arranges the selected components within a given Canvas as well as using machine learning (ML) algorithms, Natural Language Generation (NLG), or deep learning algorithms or Artificial Intelligence (AI) algorithms to generate any needed textual element.

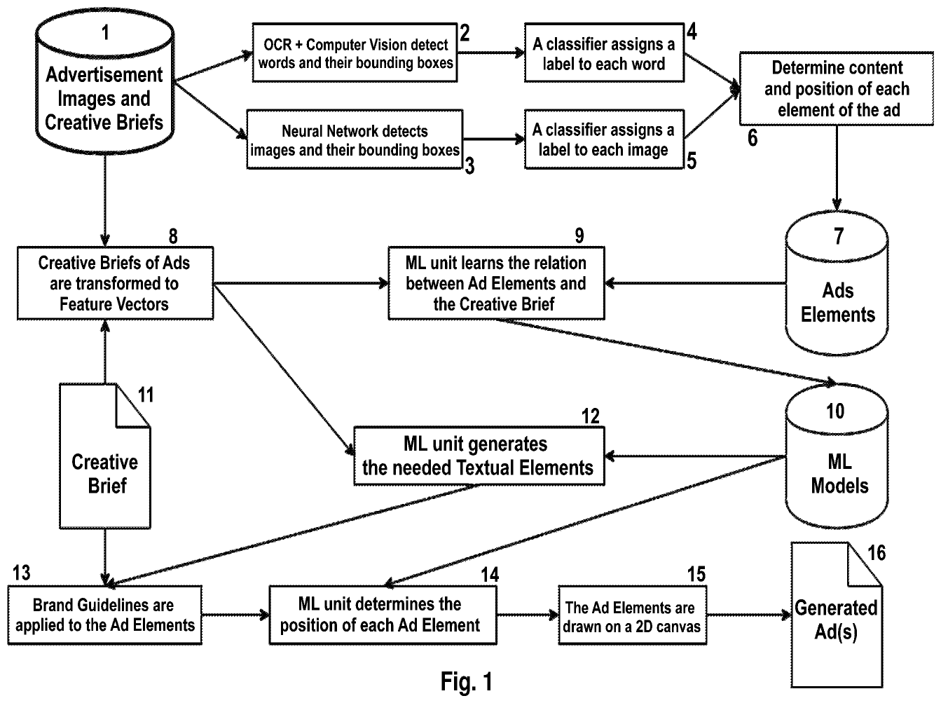

Reference is made to FIG. 1, which is a block diagram demonstrating an automated method of generating digital advertisements, in accordance with some embodiments of the present invention. The method may comprise multiple stages or phases; for example, a training phase (e.g., blocks 1 to 10), followed by an ad generation phase (e.g., blocks 11 to 15).

For example (block 1), a database containing or storing previously-prepared advertisements (e.g., in image format, or in other suitable formats) and optionally also the associated creative briefs (e.g., indicating the purpose of each ad, the target audience of each ad, or the like) is generated and populated; for example, previous ads may be provided to the system administrator by the client, or may be sourced from external data providers; may be obtained from Internet searches, or from the website(s) of the clients; may be obtained or collected automatically from search engine results (e.g., the first 75 results if an image search via an Internet search engine with a search query of “Coca Cola banner ads 2018”), or may be otherwise obtained.

Then (block 2), a computer vision module, or an Optical Character Recognition (OCR) unit or module, recognizes or detects text within each such previous ad, and/or detects the content and position of the textual elements of each such previous advertisement. For example, the text “Coca-Cola” may be recognized in such previous ads; as well as the text “Some Restrictions Apply”, or the text “Expires 06/30/2018”, or the like.

A Neural Network (NN), or a pre-trained NN or a currently-trained NN, operates to extract (block 3) images or image-components (e.g., an image of a product; an image of a person; an image of a logo of the client) from each such previous advertisement. For example, the NN may extract from a previous advertisement of Coca-Cola, (i) an image of a Coca-Cola bottle, (ii) an image of the logo of Coca-Cola, (iii) an image of a polar bear sitting on a beach towel, and/or other suitable ad components.

A text-element classifier unit (block 4) determines the textual elements or properties (e.g., headline, sub-header, call to action, legal text, or the like) that each word or phrase is associated with. Different machine learning algorithms or methods may be used by the classifier; for example, Logistic Regression, Random Forest, Gradient Boosting Decision Tree, Neural Networks, Support Vector Machines, and/or other Machine Learning (ML) algorithms or methods, Deep Learning (DL) methods, Artificial Intelligence (AI) methods, Natural Language Processing (NPL), contextual analysis, methods that utilize comparison of text elements with records stored in a lookup table or a database, or the like. For example, this Classifier may determine that a textual element of “Some Restriction Apply” corresponds to a text-element property of “Legal”; whereas, a textual element of “Click Here Now” corresponds to a text-element property of “call-to-action”.

An image-element classifier unit (block 5) determines the type or property of each extracted image (e.g., whether the extracted image corresponds to a device, an object, a person, a product, a logo, or the like). Optionally, a Convolutional Neural Network may be used by this classifier.

Based on the output of blocks 4 and 5, each advertisement is broken down or divided (block 6) into its discrete elements or components; and the content and position (e.g., absolute position within the ad; or relative position, such as, “located at the right-most quarter of the ad”) of each element are stored in an Ad Components Database (block 7), optionally with additional data or meta-data (e.g., from which ad each component was extracted; the date in which each original ad was utilized; the date of extraction of each component; the size or dimensions of each component; or the like). Any performance data or performance metrics related to that ad is also stored, and/or is tagged or associated with the relevant Ad Components or Ad Elements of such ad; for example, indicating and reflecting in the database, not only that Previous Ad Number 435 had a click-through rate of 13 percent for end-users that are geo-located in the State of Florida; but also, that the Ad Components of that particular previous ad, which were Headline Number 47 and Product Image number 38 and Call-To-Action number 92, were each associated with that same metric when they appeared together in that same previous advertisement. The stored data may include, for example: the Creative (the advertisement) that was served as will as an Advertisement ID (identifier) and the ad location (absolute location, or relative location) within the page or on the website; responder data, optionally without storing Personally Identifiable Information (PII), such as gender, age, age-range, product holding, product usage, location or geo-location (e.g., based on Internet Protocol (IP) geo-location, or based on cellular geo-location, or other methods; indicated at a granularity of country and/or state and/or county and/or city and/or other geographic region, and/or as telephone area code, or as Designated Market Area (DMA) codes or identifiers), web-site or web-page data (e.g., visit frequency, number of pages visited, order of pages visited, page views, average time spent on the entire site or in a particular page thereof), and/or other data.

Optionally, ad creative briefs (or other data-sets indicating the purpose or goals of each previous ads) are obtained and are transformed or converted (block 8) into feature vectors or feature lists that are suitable for use by Machine Learning (ML) algorithms. Different algorithms may be used to create these feature vectors; for example, feature encoding, frequency-inverse document frequency (TF-IDF), word embedding, and/or other suitable algorithms or methods.

Then, Machine Learning (ML) algorithms or operations (block 9) create models (block 10) that generate the content and determine the position of ad elements based on the feature vectors as generated or provided by block 8. Different machine learning algorithms may be used for this purpose, for example Nearest Neighbors, Gradient Boosting Decision Trees, Neural Networks, Convolutional Neural Networks, Recurrent Neural Networks, Support Vector Machines, and/or other machine learning algorithms. The specific type of algorithm is selected or determined, for example, by taking into account the nature or the type of available performance data of previous ads or of the subject-matter of the desired ad; for example, data indicating how well (or how poorly) previous advertisements in the original database performed against one or more criteria or performance indicators, wherein such performance data is used to determine the most successful or the more successful combination(s) of elements.

For example, the method of the present invention may analyze all the extracted data, as well as performance data of each previous ad; and may generate insights that indicate that previous ads that included a first particular combination of components had performed well, or that ads that included a second particular combination of components had performed poorly. For example, the system may determine automatically, based on data analysis, that: (i) previous ads in which the Logo of the client appeared, and in which the advertised produce was shown occupying at least 25 percent of the ad canvas, have performed well (e.g., have achieved a click-through rate of at least K percent, wherein K is a pre-defined threshold value); and/or, (ii) previous ads in which the Logo of the client did not appear, and in which a call-to-action of “Click Here Now” had appeared in the left half of the canvas, and in which an animation component was included, have performed poorly (e.g., have achieved a click-through rate of not more than M percent, wherein M is a pre-defined threshold value). Other suitable insights may be deduced by the system and method of the present invention, based on ML analysis of the performance data of previous ads vis-à-vis the combinations of components of such previous ads.

In the ad generation phase, a creative brief for generating a new advertisement is obtained (block 11); e.g., is provided by the user; or is generated based on one or more criteria or rules. The creative brief of the desired ad is transformed or converted to feature vectors or to feature list(s) or to feature data-set(s) that are suitable for utilization by machine learning algorithms. Different algorithms may be used to create these feature vectors; for example, feature encoding, TF-IDF, word embedding, and/or other algorithms.

The machine learning models that were created or generated in the training phase, are used (block 12) to generate the textual elements of the desired new advertisement (e.g. headline, sub-header, call to action, or the like), based on (or, taking into account at least) the feature vectors that were provided in block 8.

In some embodiments, for each copy element (ad element, ad component), the system may use a Natural Language Generation (NLG) unit or algorithm, such as, an NLG unit that was systematically trained on a bespoke corpus or a body of data or a data-set of advertising language and includes two (or more) components: title extraction, and title generation.

The title extraction component identifies and extracts the headers and sub-headers that are explicitly mentioned in the creative brief. It separates the brief text to an array or list or data-set of discrete sentences and phrases, and then uses text embeddings to identify the most similar sentences/phrases to the headers/sub-headers in the data set of previous ads.

For the title generation, a variety of approaches may be used; such as, text summarization, using a recurrent neural network (RNN) to learn the mapping between an ad description and its title, which may be deployed where sufficient data exists.

Alternatively, keyword extraction from the brief can be used to generate titles using part of speech encoding and a custom-built corpus of banner headlines to generate appropriate word colocation and sequencing. The assembled headlines are then compared to previous headlines to select the best options.

The brand guidelines specified in the creative brief (block 11), or other Ad Generation Rules/Constraints, are identified and applied to the relevant ad components (block 13); such as, rules regarding typography (e.g., which font type/font size to utilize), instructions for using the logo (e.g., Logo may cover between 20 to 35 percent of the canvas size), color rules (e.g., use Red canvas for ads greater than 200×300 pixels; use Yellow text on Red canvas), or the like. The brand guidelines may also cover or define properties or rules regarding animation of one or more elements and/or animation of the entire creative (e.g., bottom up, or side in, or top down; animation direction; animation speed; maximum number of allowed animation effects per creative; or the like), and the fade in or fade out properties or constraints, and speed or time-intervals between each of the ad frames where the client has requested a multi-frame animated ad rather than a single frame ad, or other animation-related rules or constraints.

The machine learning models that were created in the training phase, are used to determine (block 14) the position of each ad element or ad component within the new ad that is being automatically generated.

A two-dimensional drawing platform (e.g., HTML Canvas) is used to draw the ad elements or to otherwise place them onto a single canvas or onto multiple sequential canvases to form an animation, and to store or save or export the final result in image format.

The following is a demonstrative Flow of Operations through the system and method of a demonstrative embodiment of the present invention.

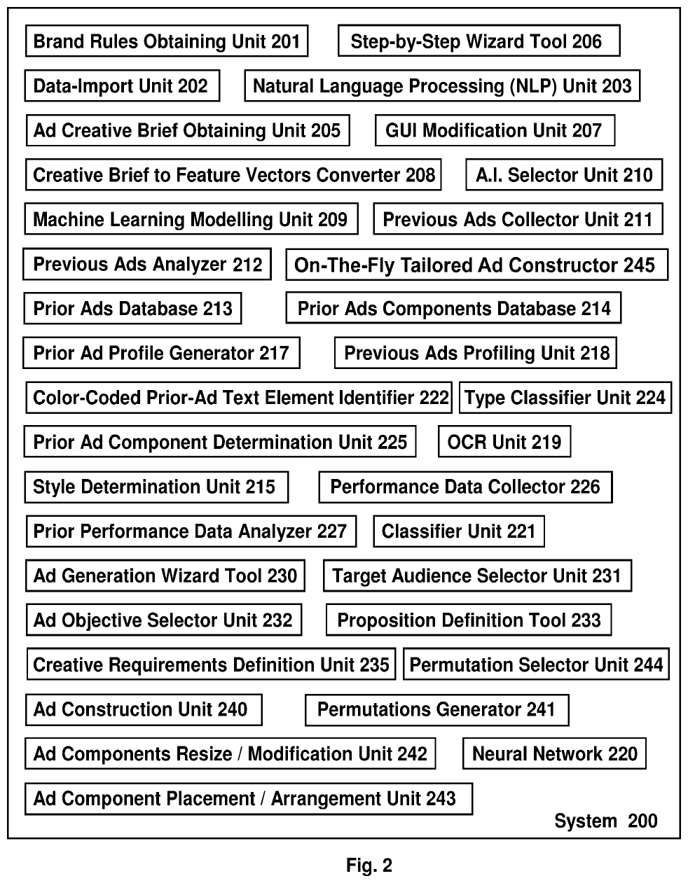

Reference is made to FIG. 2, which is a schematic illustration of a system 200 for automatic construction of advertisements, in accordance with some demonstrative embodiments of the present invention. System 200 may comprise one or more, or some, or all, of the following units or modules, which may be implemented using hardware components and/or software components.

Chris is a designer at an in-house agency of a telecommunications company. He is part of the team responsible for creating the ads required by marketing teams covering areas as diverse as Business to Business sales and Pre-Paid customer acquisition. He received a brief to create a new set of 3 frame animated acquisition ads leading with a limited time price promise.

The creation of the ads may comprise multiple steps; for example, the following demonstrative steps.

In the first step, the client may provide to the system (or, the system obtains or fetches from the client or from its data silo or repository) its digital brand guidelines or rules or constraints, such as, rules defining the characteristics of one or more items: Logo; Color Palette; Typography; Layout; Links and Buttons; Visual Hierarchy; Graphics and Icons; Images and Photography; brand voice; animation speeds and/or other brand-specific guidelines. These may be set up or defined as overall business rules, or as brand-specific rules or guidelines that the system should adhere to. The rules or guidelines may also, or alternatively, be obtained by a Brand Rules Obtaining Unit 201, as a list of data-items, threshold values, or ranges of values. For example, a rule may be “Font=Arial”, or “Font Size=14 or 18”, or “Logo Size=20 to 36 percent of entire Ad Size”, “First line animation delay of 0.6 seconds”, or the like. In some embodiments, optionally, a Data-Import Unit 202 or a Natural Language Processing (NLP) Unit 203 may extract such rules from a narrative or other document that is provided by the client or by the brand-owner, generating rules that govern layout and/or content and/or characteristics of the creative item to be generated (e.g., the advertisement).

In the second step, an Ad Creative Brief Obtaining Unit 205 of the system obtains the creative brief (e.g., from the client). This document or data-item may be completed or generated (e.g., generated by the product team(s); and checked and approved by a strategist). Optionally, the creative brief may be automatically or semi-automatically generated, for example, using a Step-by-Step Wizard Tool 206 that presents queries to the product team and then collects user responses and places them into a pre-defined template of a creative brief data-set. Alternatively, the creative brief may be generated automatically or semi-automatically by importing or converting data that is provided in other format or other structure with regard to the desired ad; and/or via NLP of a narrative that describes the desired ad.

In a demonstrative embodiment, the creative brief data-set may comprise one or more, or some, or all, of the following data-items: (1) Assignment: A brief summary of the requirement; (2) Objective: What we want the communication to do or to achieve; (3) Target Audience: Who we will be speaking to, and where will they be based; (4) Insight: Any ideas on why this campaign may be relevant to the audience; (5) Key Message, or the Proposition, which is the single idea that will motivate the audience to take action; (6) Support: The proof points that help make the case for the key message or the proposition; (7) Creative Requirements and Mandatories: What do we have to do in the creative execution, such as, use specific images, use a specific number of animation frames, use specific legal text, or the like; optionally including any limitations or ranges or threshold values with regard to the size or shape of the advertisement (in its entirety; or components thereof) due to where it will appear (on the client site vs mobile vs standard display or native social) or due to other considerations; (8) Timing(s), such as, starting date and ending date for publishing the advertisement; (9) Geographic Location(s), such as, particular cities or states or zip-codes or regions or countries or other geographical areas in which the ad is intended to be published.

Optionally, a GUI Modification Unit 207 of the system may modify or tailor the User Interface (UI) or the Graphic UI (GUI) for this specific client, to allow the client to enter the brief contents easily into the system in a way that the system will be able to use it and/or to influence the creative output effectively.

For example, a unit or module of the system, such as a Creative Brief to Feature Vector Converter 208, operates and a creative brief of a desired ad is transformed or converted or translated into feature vectors, that are suitable for use by the system and by its machine learning algorithms. Different algorithms may be used to create or to automatically generate such feature vectors; for example, feature encoding, TF-IDF, word embedding, and/or other algorithms.

Machine Learning (ML) algorithms, implemented via a Machine Learning Modelling Unit 209, may be used to create models that generate the content and determine the position of ad elements, based on the feature vectors that are generated according to the creative brief inputs. Different machine learning algorithms may be used for this purpose, for example Nearest Neighbors, Gradient Boosting Decision Trees, Neural Networks, Convolutional Neural Networks, Recurrent Neural Networks, Support Vector Machines, and/or other machine learning algorithms.

In some embodiments, an Artificial Intelligence (AI) Selector Unit 210 of the system may automatically select or determine the specific type of algorithm, for example, based on (or, by taking into account) the characteristics of available performance data with regard to previous ads and their respective performance; namely, based on data indicating how well (or how poorly) ads in the original database of prior ads had performed against one or more criteria, which is used to determine what the most successful combination of elements will be selected for the creative brief currently being processed.

In the third step, a Previous Ads Collector Unit 211 of the system obtains copies of, and data about, previous ads that had been previously created and utilized (e.g., published); for example, receiving automatically via an API or downloading manually from the client data warehouse or data silo or other repository or from software in the client marketing stack, such as Adobe Experience Manager, or from a third-party service provider that stores and/or publishes and/or hosts and/or serves and/or monitors and/or tracks advertisements on behalf of the client or for the client. or the like. Optionally, the system imports or scans such prior ads, and a Previous Ads Analyzer Unit 212 enables all the elements or components of each prior ad to be recognized, identified, classified and separated out into a database. For example, prior ads are stored in a Prior Ads Database 213; and their discrete ad-components are stored in a Prior Ads Components Database 214.

Optionally, a Style Determination Unit 215 may also detect, and the system takes into account, the relative location or position of ad components in a prior ad or in multiple prior ads (e.g., detecting that the Logo is always presented at the top-right corner of the ad), to automatically identify or detect a client-specific (or, brand-specific) style and/or a preferred way of laying-out an ad; and such detected features or insights may be regarded as a Profile that is automatically generated by a Prior Ad Profile Generator 217, e.g., generating a group or set of (i) defined elements in a (ii) particular configuration relative to each other in a (iii) specific ad format.

In accordance with the present invention, profiles are not merely templates. For example, a template sets out very specific (normally down to the pixel) variable and non-variable areas of an advertising creative execution. In contrast, with a profile, the elements are assigned general areas and will dynamically adapt to positions or locations or regions within the ad format, based on factors (e.g., dynamically changing factors) that may include image size; headline size; copy length or text length; ad rules or client rules or brand rules (e.g., from brand guidelines), or the like. The system may dynamically bring the elements together and may dynamically determine the location or position of each component, rather than assigning each element to a pre-defined, pixel locked position, based on performance data that is manually and/or automatically fed back into the system, and which may be used by the system, in a continuous manner or in an iterative process, to further generate new combinations or new elements and new permutations of ad components and ad elements, thereby generating new creatives (new advertisements) and again feeding into the system their performance metrics data in order to be utilized iteratively in a next batch or next round or next iteration of ad generation, for the same product (or service) or even for a different product (or service) of the client.

The system may identify multiple profiles for different types of ads (e.g., of the same client, or of the same brand-owner, or of the same brand). In a demonstrative example, the same brand-owner may utilize three different recruitment profiles for the same ad format (e.g., 300 by 250 pixels); such as, (1) half image horizontal, in which a top half of the ad contains text, and the bottom half of the ad contains an image; (2) half image vertical, in which a left-side half of the ad contains text, and a right-side half of the ad contains an image; (3) full image, in which the entirety of the ad canvas includes an image, and a text is optionally shown onto a particular region of that ad (e.g., onto the top-left quarter of the image).

In a demonstrative embodiment, the above-mentioned Prior Ad Profile Generator 217, or a Previous Ads Profiling Unit 218, may enable profiling of a prior ad, for example, by detecting in the ad itself some or all of the following features: Logo; Pre-header; Headline; Sub-header; Body copy; Legal copy; Call to action; Image; Background color; Design element (e.g., usually based on the brand guidelines).

The ingestion or analysis or importing previous ads, may comprise an OCR process by an OCR Unit 219, to detect the content and position of the textual elements of each prior advertisement. A pre-trained Neural Network 220 is used to extract the images from each prior ad (such as, an image of a product, or a person). A Classifier Unit 221 operates to determine the textual element (e.g., headline, sub-header, call to action, legal text, or the like) that each word is associated with. Different machine learning algorithms may be used to implement such classifier units; for example, Logistic Regression, Random Forest, Gradient Boosting Decision Tree, Neural Networks, Support Vector Machines, and/or other machine learning algorithms.

Optionally, a Color-Coded Prior-Ad Text Element Identifier 222 of the system generates color coded areas of each prior ad, based on element recognition; and then sets out the copy below the ad with the relevant color. For example, the system automatically identifies in a prior ad, the Logo of the brand-owner; marks it in Yellow color in the copy of the prior ad; and shows beneath (or near) the prior ad this Logo in yellow color. Similarly, the system automatically identifies in the prior ad the Call to Action; marks it in Red color in the copy of the prior ad; and shows beneath (or near) the prior ad this Call to Action in red color. This unique presentation enables to efficiently perform visual checks or quality assurance; and may be performed for each prior ad.

A Type Classifier Unit 224 determines the type of each image (e.g., device, person, or the like); optionally, a Convolutional Neural Network may be used to implement this classifier.

Based on the output from the above, each prior advertisement is broken down or is divided to its discrete elements or ad-components, by a Prior Ad Component Determination Unit 225; and the content and position (or other meta-data) of each element is stored in the prior ads database.

In the fourth step, a Performance Data Collector 226 causes performance data of prior ads to be obtained or imported into the system. This data enables the system of the present invention to generate insights for automatically or semi-automatically generating elements and then using those elements in constructing and creating better-performing ads based on the performance of previous ads, as the system knows what is working well or what is working poorly. The performance data supplied is, for example, where the ads appeared (e.g., website); Intended target audience (e.g., who we were trying to reach and details of that audience); Results (e.g., what was the click-through rate); and/or other performance parameters (e.g., previous cost-per-click; previous cost-per-mille; previous conversion rate; or the like).

Optionally, the performance data is analyzed by a Prior Performance Data Analyzer 227, and the relevant ad performance data-items are appended to the corresponding ad elements (of the prior ad) and the profile (of the prior ad), so that the system may use the performance data to generate new ads at a later time. For example, the system may store insights that indicate that Prior Ad number 145, having a Logo that occupied 12 percent of the entire ad space, performed poorly at 1% conversion rate; whereas, Prior Ad number 158, having a Logo that occupied 28 percent of the entire ad space, performed well at 24% conversion rate. This also applies to a combination of variables such as logo and color background.

In the Ad Generation phase, the system of the present invention shows to Chris the “Login” screen or another initial screen; he selects “Creator Dashboard” or a similar interface element, which takes him to a page or an on-screen interface showing all recent/previous campaigns (e.g., from the past two months or two years). He selects “Create New”, and triggers a step-by-step Ad Generation Wizard Tool 230 for a new campaign, which allows him to select or otherwise input data with regard to (for example): the Target Audiences; the Ad Objective; the Proposition; the Creative Requirements.

For example, a Target Audience Selector Unit 231 allows to select from a Target Audience from a drop-down list or menu of potential audiences that have been pre-populated in the system. Chris selects: Consumer; Not an existing customer. He also selects a series of regions that the offer is appropriate for (e.g., west coast; Chicago DMA; Scarsdale store catchment area).

An Ad Objective Selector Unit 232 allows him to utilize a drop-down menu based on how his company classifies the purpose of their ads. Chris selects, for example: Acquisition; Price promotion led.

Chris answers a further question through the step-by-step wizard: What do you want the audience to do in response to the generated ad? He selects from a drop-down menu of options, for example: to drive clicks-through to the Company's website.

A Proposition Definition Tool 233 allows Chris to define the Proposition which originates from the creative brief for the new ad to be generated. Chris enters the proposition sentence directly from the brief, e.g., by manual typing or by commanding the system to automatically import it from the brief; for example, the Proposition being, that a discount of $10 off per phone line is offered for the first year if the end-user signs up for a new line in the next two weeks. He then also adds any proposition support points; and adds any legal requirements, such as by selecting items from existing legal copy or the option to add a new set (e.g., “Some Restrictions Apply”, or “Void in Arizona”).

A demonstrative interface may thus allow the user Chris to provide step-by-step input, along the lines of the example shown in the following table:

| | |
|---|---|
| (1) Select the Appeal for the new ad | Select: Price/Feature/Offer/Brand |
| (2) What is the most important thing | Provide the core idea/proposition |
| to show or say in the new ad? | of the new ad |
| (3) What is our proof/support | Provide info that supports the |
| | proposition. |
| (4) Any further key product support | Provide further copy support |
| points? | points |
| (5) Images to be used | Select images from client Digital |
| | Asset Management System |
| (6) Any Terms & Conditions/Legal? | Yes/No; select from drop-down |
| | menu |

A Creative Requirements Definition Unit 235 enables Chris to review or select elements that will define how the creative will look. For example, it allows Chris to select a presentation style, from a list of available options such as: text only; design elements+text; image+text; image+text+design elements; other options such as the number of frames required. One of the other options that may be generated by the system may be, for example, “use the profile that had performed the best in the most-recent N months (or, in the most-recent M campaigns; or, in the year 2018; or generate 3 versions for testing, or the like). Upon selection, and particularly if the “best performing profile” option is selected, the system may obtain new images and/or new text for the new ad; for example, enabling the user to type them manually, to upload them, to point to a linked library of images or text, or the like.

An Ad Construction Unit 240 of the system is now ready to generate an ad or series of ads for Chris. For example, the ad creative brief (for a new desired ad) is transformed or converted into feature vectors that are suitable for use by machine learning algorithms. Different algorithms may be used to create these feature vectors; for example, feature encoding, TF-IDF, word embedding, and/or other algorithms. The machine learning models that were created in the training phase, and the NLG models which have been trained on an advertising specific corpus (or that utilize an advertising-related or marketing-related dictionary or data-set or word-bank, for training and/or for various methods of generating natural language phrases), are used to generate the textual elements of the advertisement (e.g., headline, sub-header, call to action) based on the feature vectors provided by the ad creative brief of the new desired ad. The text may be generated by the system from, or based on, a combination of historical data and/or the creative brief, using NLG and/or phrase generation, and/or by other methods of text generation (e.g., by utilizing a lookup table; by using a pre-defined list or set of rules or conditions for word selection; by utilizing a synonym generator module or a thesaurus module; or the like). The brand guidelines or the ad rules, which are specified in the creative brief, such as typography, instructions for using the logo, or the like, are applied to the ad elements or are otherwise enforced or applied (e.g., the system automatically re-sizes ad elements, rotates them, changes their foreground color and/or background color, increases their size, changes their size, or the like). The machine learning models that were created in the training phase, are used to determine the position of each ad element in the new ad to be generated. A two-dimensional drawing platform (such as HTML Canvas, or other suitable platform or tool) is used by the system, for example, to draw or place the selected ad elements in a single frame or multiple frames required for animation and to store or save or export the final result in image format or in other suitable format (e.g., PDF file, vector graphics, bitmap graphics). The system also provides for animation options, for example, to modify the speed of frame change, direction, build order and speed of copy/image animation per frame; the system may autonomously define such animation-related properties, based on past performance of ads; and may further enable a user to modify or fine-tune such properties.

For example, a Permutations Generator 241 generates multiple combinations or permutations of some ad components from the database of ad components of prior ads; an Ad Components Resize/Modification Unit 242 performs resizing and/or other modification(s) of each selected ad-component, in each permutation or combination; an Ad Component Placement/Arrangement Unit 243 places or arranges the selected ad components within or on a pre-defined advertisement canvas or space; for example, by taking into account historic performance data of each ad component, and of particular combinations of two-or-more ad components. For example, the system may determine that performance data for Ad Component number 183, which is a Logo that occupies 11 percent of the ad space, indicated poor performance (e.g., across multiple different prior ads); and therefore, this particular ad component will not appear in any generated combinations. Additionally or alternatively, the system may determine that including of the Call To Action in font Anal Bold size 18, yielded successful performance; and therefore this particular ad component should be included in at least some of the generated combinations. Additionally or alternatively, the ML process of the present invention may determine that the particular combination of a Call to Action in the right side of the ad, with a Logo on the left side of the text, had yielded poor performance of such ads; and therefore this combination or word use, should be avoided, for example, by choosing different placement of these components and different headlines, subheads or Call to Action (CTA elements) within the generated permutations. Other suitable criteria may be used, and other modifications of location, placement, size, colors, inclusion of ad components, discarding of ad components, or other determinations may be performed based on ML processes that take into account the historic performance of ads having such ad components therein. Accordingly, a Permutation Selector Unit 244 determines which combinations or permutations of ad components to discard; which combinations or permutations of ad components to maintain; and/or which combinations or permutations of ad components to re-arrange or to modify in particular manner in accordance with the ML models that indicated which combinations of ad components have performed well for prior ads.

The system may now generate multiple different ads, optionally accompanied with a set of data based justifications next to each ad indicating why the system generated each such ad. Optionally, wording or content of an ad component (in the newly-proposed ad) may be selectively modified by a reviewing user, and multiple variations are then automatically re-generated by the system based on such introduced changes.

Optionally, upon selection of a particular proposal or direction (e.g., by a reviewing team), the system may generate regional variations based on historical performance data; for example, tailoring the proposed ad to East-coast states, to West-coast states, or the like, based on pre-defined rules or criteria for such adaptations or tailoring process (e.g., a rule that “for West Coast states, change the Call To Action colors to be yellow-on-red”).

Optionally, the Advertising Campaign may be launched and may go live. For example, performance data is provided back into the ad generation system, and is sorted and matched by the system against the ads that were generated; and a performance analysis unit of the system may determine which headlines and colors (or other ad components) worked better (e.g., in general, or in particular geographical regions or market-sectors). Optionally, such performance data is used to drive new iterations of ad generation by the system.

Optionally, the system may enable micro-targeted and personalized level of ad generation for each new ad or for each brand or client; enabling the system to rapidly and efficiently generate multiple ads with different layouts and to perform infinite or virtually infinite testing on them, and then to utilize the infinite or virtually infinite testing results to discard of poorly-performing ads, to maintain well-performing ads, and/or to modify an ad based on other insights derived from other tested ads. This may be performed on a per-ad basis and even on a per-ad-component basis, across all elements and their combinations. Some embodiments may thus reduce the cost of creative generation and ad generation; and may provide a data driven path to meaningful increased conversion rates, thereby driving down the cost of acquisition and increasing customer lifetime value.

The system of the present invention analyzes the content and/or performance of existing or past or historical ads and/or campaigns, and learns from such analysis, or extracts or deduces insights from such analysis in order to generate and/or fine-tune and/or modify ad(s) for the same client and/or for other clients. For example, machine learning (ML) and/or supervised learning and/or supervised ML is utilized to train an algorithm to identify the individual components of an ad (e.g., headline, sub-head, call to action (CTA), legal copy, or the like), and to build a database which stores these ad components as discrete elements. The system also takes into account the relative location of each component within the ad and/or within he screen, thereby enabling the system to identify or detect a common style or look-and-feel for ads of a particular client or for ads in a particular field or industry (even across multiple clients; such as, telecommunication clients; car makers and automotive industry; or the like), and further deduces or detects preferred way(s) of laying out an advertisement, denoted as a “profile” for such client (or for a group or batch of clients). The profile is defined as a group or set or assembly of specific components or ad elements, arranged or placed in a particular configuration (location, position) relative to each other, in a specific ad format (e.g., within a specific ad size or canvas size).

In accordance with the present invention, “profiles” are not templates. A template generally sets out very specific (normally down to the pixel) variable and non-variable areas of an advertising creative execution, and is used for conventional Dynamic Creative Optimization (DCO). However, in contrast with DCO's templates, with a profile, the system of the present invention dynamically brings the elements together rather than assigning each element to a pre-defined, pixel-locked position on the canvas. Additionally, a conventional DCO system may, at most, operate to optimize a pre-defined and already-generated set of finite elements or multiple versions of the same ad; whereas, the system of the present invention may infinitely vary any element and/or combination of elements, based on performance data points to evolve the creative over time, and uniquely, to autonomously generate brand-new advertisements based on machine-selected permutations of ad elements extracted from previous ads of the same client while taking into account (i) past performance metrics of those past ads, and (ii) brand guidelines that should be adhered to, and (iii) a Creative Brief for the new advertisement intended for automatic generation.

As a non-limiting example, a “template” may rigidly indicate that the Title must be a rectangle of 200 by 50 pixels, and must be located at a vertical offset of 10 pixels from the top-most edge of the ad canvas and at a horizontal offset of 20 pixels from the left-most edge of the ad canvas. In contrast, a “profile” generated (and later, utilized) by the system of the present invention, may include dynamic and non-rigid or less-rigid characteristics; such as, that the Title should be a rectangle of either 200×50 or 180×40 or 160×45 pixels, or that the Title should be a rectangle having a width in the range of 160 to 190 pixels and having a height of 30 to 48 pixels; and that the Title element should be placed at the top-most 10 percent of the ad canvas, or at the top-most and left-most 20 percent of the ad canvas, or at the vertical top-most of the ad canvas while being horizontally centered or almost-centered (e.g., within 10 percent horizontal margin of being exactly centered), or the like. The system may also determine, for example, that based on performance data or past performance metrics of previous ads, the title should be increased in size by 50%.

In a demonstrative embodiment, the system utilizes an OCR unit which detects the content and position of the various (e.g., textual) elements) of the advertisement. A neural network, trained on manually-labelled or pre-labeled images, is used to extract the images (such as an image of a product, or of a person) from the advertisement; and a customized Convolutional Neural Network (CNN) is used to classify the type of each image (e.g., device, person, or the like).

A machine learning classifier, such as Support Vector Machine (SVM), Decision Tree, Gradient Boosting, or the like, operates to determine and/or classify the textual element (e.g., headline, sub-header, call to action, legal text, or the like) that each word or text-portion is associated with; optionally by utilizing a pre-defined list or lookup table of classes or such textual elements.

Based on the output from the above, each advertisement is broken down to its elements; and the content, the position, and bounding boxes of each element (with the respective classification of each element) are stored in a database; such as, with a multiple-fields record corresponding to each analyzed advertisement. Along with the element data, the system also stores any available data associated with that ad under a unique identifier (Ad Tag) for the specific version of the ad that was run. Such data includes, for example: Business Objectives; Target Audience; Media placement; Key Performance Indicators (KPIs) such as impressions, clicks, qualified traffic generated, click-through rate, cost per click (CPC), conversion rate, and cost per acquisition.

The system then proceeds to read or analyze the creative brief, for the purpose of automatically generating one or more new ads for the client. Once the creative brief is entered and saved in the system, an analysis unit takes the brief content and converts it into a format that can be used by a set of ML models which may then generate the ad layout and the ad copy. For example, the content of the creative brief is transformed to feature vectors that are suitable for use by ML algorithms. The content can be in free format and/or in particular formats from selected options or pre-defined formats. One or more custom algorithms may be used to create these feature vectors; for example, general feature encoding for non-textual data, and word embedding for text data.

The system then proceeds to automatically and autonomously generate a proposed advertisement, or a digital ad concept that can be single-frame or multi-frame, with animation or without animation (e.g., with animation of the copy element only, or other ad elements). The system may utilize a pre-defined range of frames (e.g., 1 to 4 frames, or other range). The proposed ad(s) are shown to a user, who may edit and/or modify and/or approve and/or reject each ad. Upon approval, the system generates the actual code-portion or code-segment for the ad (e.g., as HTML5 code, and/or with CSS or JavaScript code elements, and/or with JPG or PNG or GIF or Animated GIF file(s) for graphics content, and/or as MP4 files or other audio/video format), for further utilization in programmatic systems or ad serving systems or publishing systems.

For example, the system trains an algorithm to assemble ads using the optimal combination of ad-components and layout, as deduced based on existing or past performance data of other ads of that client (or even: of other clients in the same industry or in a similar field). A machine learning (ML) algorithm trained on the performance data-set for these ads, operates to select the most relevant ads and uses their layout to automatically generate the newly-proposed ads.

Optionally, relevant elements may be inserted into the ad layout. Data permitting this may be used to generate individually personalized ads; and the number of personalized ads may only be limited to the possible combinations or permutations that can be derived from the available data.

The layout of each ad may be determined by the system in various ways; for example: (a) Using the Profile(s) generated in the initial training phase, and selecting the optimal layout as described above; (b) based on client-specific detailed brand guidelines, which may be implemented in the system as business rules, defined in an appropriate format (e.g., JSON) and used to define typography, logo placement, or other layout parameters, for any number of layouts that the client guidelines define.

For each copy element, a Natural Language Generation (NLG) unit operate to perform title extraction and title generation. The title extraction process identifies and extracts the headers and sub-headers that are explicitly mentioned in the brief; for example, it separates the brief text to an array of discrete sentences and phrases, and then uses text embeddings to identify the most similar sentences/phrases to the headers/sub-headers in the data set of previous or historical ads (e.g., of the same client). The title generation process may utilize one or more methods, such as, text summarization, using a Recurrent Neural Network (RNN) to learn the mapping between an ad description and its title; and this mechanism may be deployed particularly where sufficient historical data exists with regard to previous or historical ads of that client. Additionally or alternatively, keyword extraction from the brief can be used to generate one or more proposed titles, using part-of-speech encoding and/or by utilizing custom-built or pre-defined corpus of advertising copy or historical advertisements or past ads or previously-utilized ads, to thereby generate appropriate word colocation and sequencing and thus yielding proposed Titles or headlines or sub-headlines or calls to action (CTA elements). The assembled headlines may also be compared to previous headlines, optionally by taking into account the past performance characteristics of previous ads with those headlines, in order to detect and select the best options. The user may then edit the system-suggested ad, for both copy and layout, optionally utilizing a drag-and-drop interface to move ad elements within an on-screen canvas; and may save or send the modified ad for review or approval by others, and/or for review by the system which may check whether or not the user-modified ad falls within the approved brand guidelines and/or within other constraints and features that are defined in the business rules or in the creative brief and/or that were generated by the system in view of analysis of past ads. Optionally, the system may alert the user and/or third parties, that a user-modified ad does not comply with a particular constraint that was defined in the creative brief and/or business rules of that client, and may request a manual confirmation to override and approve the ad.

In some embodiments, the system generates and outputs a two-dimensional (2D) storyboard for approval; such as, in the form of a PDF file, or a graphical image (PNG or GIF or JPG or TIFF, or the like), on using other suitable file format (e.g., as a Microsoft Word document that includes text and images). The system then requests approval from one or more or from a pre-defined number of approving entities or users; and then outputs a programmatic-ready implementation of the ad concept in the appropriate format (e.g., as HTML5 code and/or with additional elements such as JavaScript code, CSS code, PNG or JPG or GIF files, or the like).

In the case of static ads, an automated 2D drawing platform is used by the system to perform the automatic drawing or placement of the ad elements onto an ad canvas, and to store the result in image format or in other formats. For animated or interactive ads, the ad generation algorithm will generate multiple sequential frames. The system may export the ad in HTML5 format (optionally with CSS or JavaScript code segments), or may generate animated output in other formats (e.g., as an Animated GIF file; or as an MP4 video file; or as a video within an FLV container).

Optionally, each ad is also tagged by the system with a unique identifier, so that any data relating to the placement and performance of the ad concept can be assigned back to the individual ad specifications. This data may be obtained from the interaction on an external site, and/or from the client's own marketing stack, and/or from analytics data regarding ad performance as obtained from an ad serving system and/or from a third-party provider of ad analytics or ad performance metrics. In some embodiments, the system ensures that the data is associated with the client at the immediate time-point of ad creation, and this it becomes more efficient and less problematic to later match available attribution and performance data to the individual execution, and easier or more efficient to start calculating Return On Investment (ROI) in terms of ad cost/placement/results. This data is further used by the system when new ads are generated, so that the system is constantly improving and evolving layout and copy based on the data-points stored against each execution in the database. Optionally, a feedback loop or an ad performance analytics unit may provide updates to the system, from an ad serving platform and/or from an ad metrics platform, and such updates may further be taken into account in the next iteration of generating ads by the system.

The system of the present invention may further utilize Artificial Intelligence (AI) in order to automatically and instantaneously create brand-compliant, data-driven, static (single frame) or multi-frame (e.g., animated), advertising concepts and actual placement-ready ads or ad units or digital ad units, that are optimized and personalized and tailored to a specific customer or prospect, at any digital point of interaction with the customer or prospect. To ensure brand compliance, the system analyzes and learns from existing (past) work and past ads of that brand, detecting and identifying a house style or look-and-feel and a preferred way of laying out an ad, in view of previous ads of that customer and optionally by taking into account their past performance; optionally augmented with brand guidelines and/or business rules which may be inputted into the system. The generated ads may be a single-frame static ad, or may be a multiple-frame animated ad or video-based ad, having length and complexity that are only limited by the available data and processing power. The system uniquely generates advertising concepts using a combination of (i) analysis and learning from existing (historical) ads and their past performance, and (ii) the automatically ingested client creative briefing document; in order to automatically generate completely new creative concepts and digital ad units, via a computerized platform that is able to analyze the data and generate proposed ad units in a matter of milliseconds or in a few seconds; thereby replacing dozens of hours of manual labor that a team of human marketing experts would need to invest in order to come up with a similar proposed ad, which (if performed by humans) would not even be able to correctly identify the ad elements and the ad characteristics that have led in the past to superb or increased or improved performance of certain previous ads, and/or which (if performed by humans) would not even be able to correctly identify other ad elements and the characteristics that have led in the past to poor or inadequate or reduced performance of some previous ads.

In the data-driven approach of the system, each ad execution is generated with a unique ID immediately at source, from the time-point of initial automatic ad generation by the system. Any change or modification in any element or properties or layout or content of the ad, results in a new ID being generated so that the system can identify and track elements that are impacting performance and may update creative generation accordingly. Data from new (system-generated) creative executions are fed back into the system, via the client marketing stack and/or from the programmatic media partner and/or from other sources (e.g., ad performance analytics provider, or ad metrics provider, or analytics data from the client's account at an ad serving platform or an advertising placement platform). This data is fed in real time or in near real time, or in some implementations on a periodical basis (e.g., hourly, daily, weekly), optionally via APIs connected to the programmatic partner (or to the other data source) and to components of the client's marketing stack (e.g., their e-commerce site). This data includes, for example: business objectives; target audience; media placement and KPIs such as impressions; clicks; qualified traffic generated; click through rate; cost per click; conversion rate, and cost per acquisition. This data is added to the details of each execution (e.g., color; call to action placement; headline copy; or the like) and is further used to optimize the subsequent iterations of ad generation by the system.

As an optimized and personalized approach, and since the Ad ID may be held on the client side, the system may cleanly navigate around or may avoid privacy issues, while still using a real-time data feedback loop from the programmatic team or from the client's marketing stack (e.g., data such as clicks/views versus customer profile), such that the ads and their respective performance data can be updated per customer.

The system may generate ad concepts and digital ad units that can be used on any digital platform in real time or in near real time. In some embodiments, the system may generate proposed ads in an automatic and autonomous manner in advance, and such proposed ads may then be reviewed by a human reviewer who may approve, reject, or modify each proposed ad. In other embodiments, particularly given a sufficient amount of real-time processing resources and memory resources, an autonomously generated ad may even be created by the system in real time, immediately prior to its being served to the end-user/consumer himself; in a process that takes into account not only the general performance data of previous ads of that advertiser, but rather, also takes into account the particular performance data of previous ads of that advertisers that were shown to this particular end-user (e.g., tracked via a cookie or an HTML beacon element or tracking pixel or tracking iFrame or other tracking element) or to a group of end-users that the current user belongs to (e.g., users that are located in the United States based on IP geo-location; or, users that are located in Florida based on IP geo-location; or, users that are females in the age range of 20 to 30 years old based on access to user data or user profile via an advertising network or a social network; or the like).

In some implementations, the system may tailor and construct on-the-fly a specific digital ad unit, to be served to a particular end-user, based on analysis of past or historical data that relate specifically to this user or to a group or batch or affinity or type of users that the current end-user is known (or is estimated) to belong to. This may be performed, for example, by an On-The-Fly Tailored Ad Constructor 245, or other suitable on-the-fly user-specific or user-tailored ad generator or constructor unit.

In a demonstrative example, an advertising platform or advertising system or a search engine or a social network is being utilized, via an electronic device (e.g., laptop computer, desktop computer, smartphone, tablet, smart-watch, smart TV, gaming device, or other device), by a particular end-user. The system may have access to data that indicates that this particular end-user is a male of 25 years old, or is a male in the age-range of 20 to 30 years old, or is a male that in the past have browsed online stores that sell high-tech gadgets; and may even have access to other data of that user (e.g., full name, exact age or date-of-birth, email address, current location) as obtained from a logged-in social network session (e.g., the end-user is currently logged-in to Facebook or Twitter or YouTube or Instagram or Pinterest or LinkedIn, or to his Gmail or Google or Yahoo account). The advertising system determines that this user, that requested information (e.g., an article, a product, a search query) about a particular topic (e.g., “Virtual Reality head-gear”), should be served with an advertisement from an Electronics Gadget manufacturer; for example, based on a real-time bidding or auction in which that particular manufacturer has bid 70 cents to show an ad to males in the age-range of 20 to 30 years old that are located in Florida and that have entered a search query that include the string “Virtual Reality”. However, instead of merely fetching a pre-defined ad from a pool of suitable ads/ad elements of that particular Manufacturer, the system of the present invention may operate in real time to generate and to construct on-the-fly a particular digital ad unit that is specifically tailored to this specific end-user; by performing rapid analysis of the past performance of historical ads, of that same advertiser, that had been served in the past to males in the age range of 20 to 30 days, or even, only of historical ads that were served in the past by that particular advertiser to this particular end-user, and by determining which ad layouts and ad content elements have performed the best in such historical ad servings; and based on such analysis, which may be performed within milliseconds or very few seconds given suitable processing resources and memory resources, the system generates and constructs in real time a digital ad unit that comprises ad elements that were either extracted or newly generated based on learnings from historical ads as best-performing or as optimally-performing for this specific advertiser when served to this specific end-user (or, to this specific type of end-users that the current end-user belongs to); and the digital ad unit is then immediately served to that specific end-user, and its performance is tracked (e.g., via a unique Ad ID or Ad Tag) and is fed-back to the system's database to allow for even more accurate user-specific tailored ad construction on-the-fly.

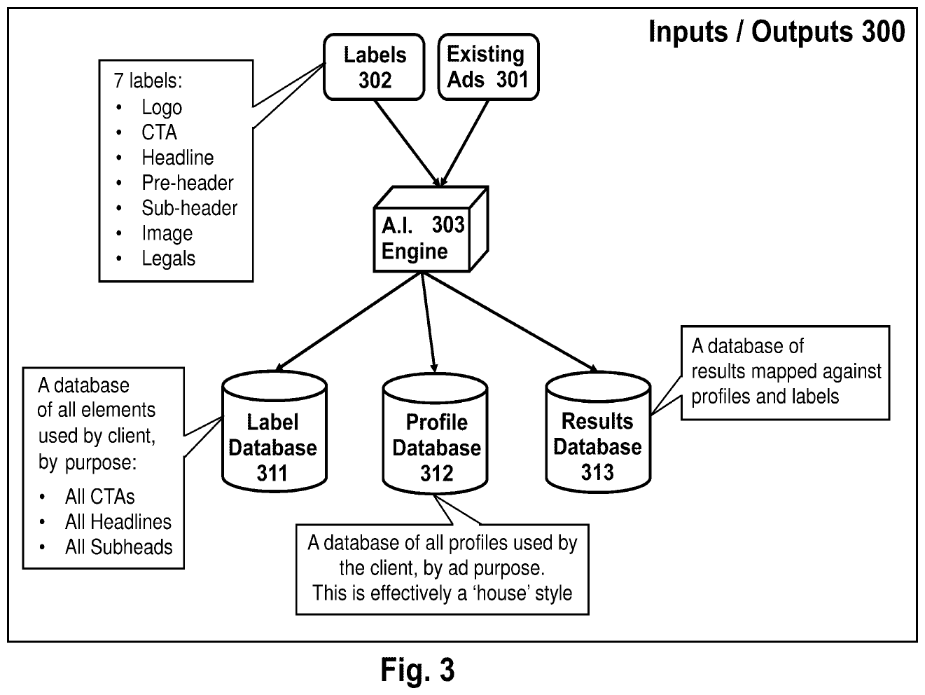

Reference is made to FIG. 3, which is a schematic illustration of a set of some inputs/outputs 300 which may be utilized and/or generated in conjunction with automatic generation and construction of advertisements, in accordance with some demonstrative embodiments of the present invention. For example, existing ads 301 (or previous ads, or historic ads, or previously-used ads) as well as suitable Labels are fed into an AI engine 303; which in turn populates multiple databases, such as: a label database 311, a profile database 312, and a results database 313. The populated data may subsequently be used by the automatic ad construction unit of the present invention, as detailed above.

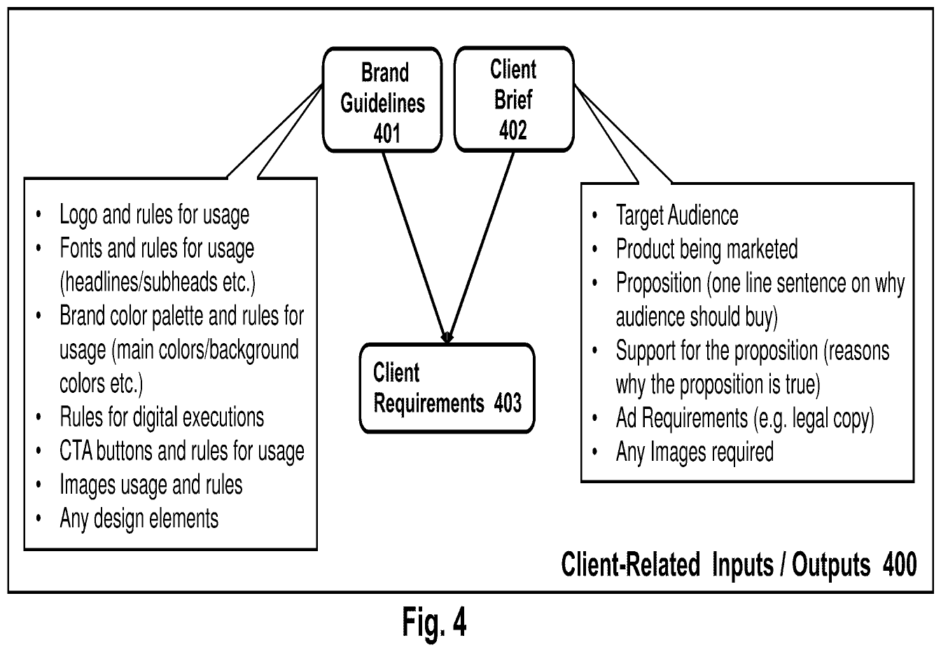

Reference is made to FIG. 4, which is a schematic illustration of a set of some client-related inputs/outputs 400 which may be utilized and/or generated in conjunction with automatic generation and construction of advertisements, in accordance with some demonstrative embodiments of the present invention. For example, the client-specific Brand Guidelines 401, as well as the client-specific Client Brief 402, may include data-items that are fused or analyzed by the system to generate a set of Client Requirements 403, which are subsequently used by the automatic ad generation and construction unit of the present invention, as detailed above.

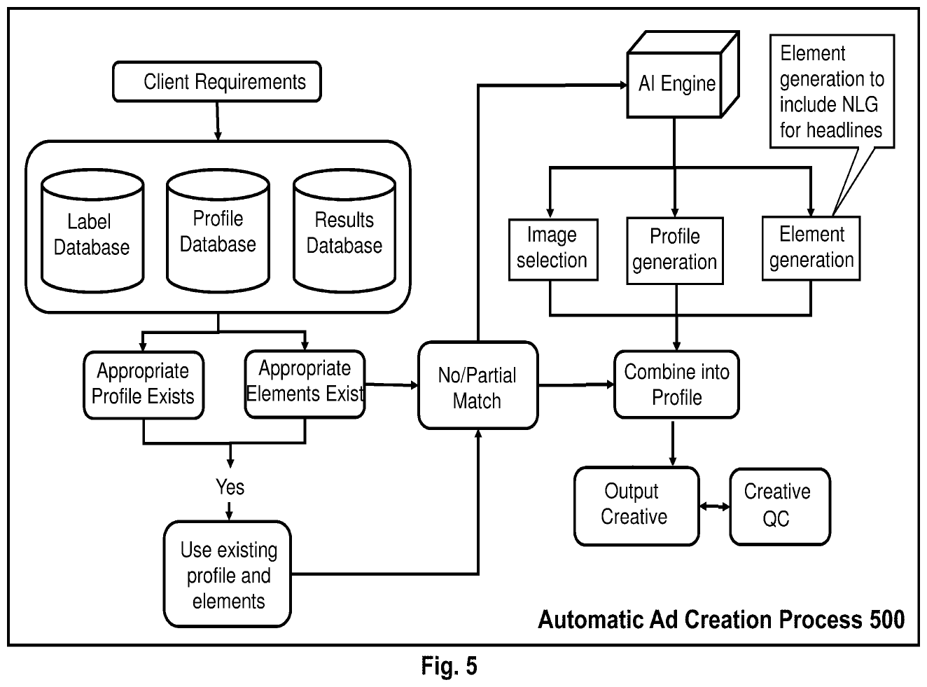

Reference is made to FIG. 5, which is a schematic illustration demonstrating an automatic ad creation process 500, in accordance with some demonstrative embodiments of the present invention. For example, Client Requirements as deduced or extracted or generated (FIG. 4), are analyzed in view of the Label Database, the Profile Database, and the Results Database (FIG. 3); and the system checks whether an appropriate match exists, or an appropriate match does not exist, or only a partial match exists. If a match exists, then the matching existing profile and the matching existing elements are used as additional input(s); and the data is fed to the AI engine, which performs image selection, profile generation, and elements generation. These outputs are combined into a specific profile, and a creative (an ad) is automatically generated, and is passed to a Quality Control (QC) or Quality Assurance (QA) unit or terminal.

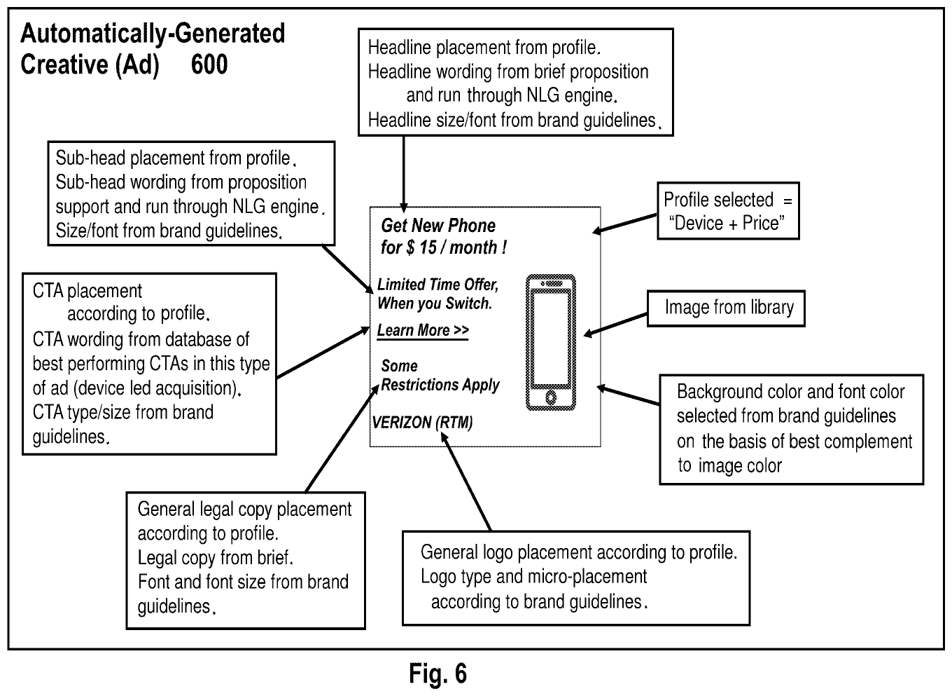

Reference is made to FIG. 6, which is a schematic illustration demonstrating an automatically-generated creative (ad) 600, in accordance with some demonstrative embodiments of the present invention. Demonstrated are, for example, selection/generation and placement of the Headline; selection/generation and placement of the Sub-Head or Sub-Headline; selection/generation and placement of the call-to-action (CTA); selection and placement of the legal copy or legal terms or legal portion of content; the selection of the relevant profile (e.g., “Device+Price”); the selection of the image from a library or database of relevant images; selection of the background color and font color and font type (e.g., based on the Brand Guidelines, with best match relative to the image color); and the general and specific placement of the Logo.

For demonstrative purposes, the following Table shows a database of ad elements used in past ads of a particular client, together with a Click-Through Rate (CTR) performance metric.

| | | Sub- | Logo | Logo | Image | | | CTR/ |
|---|---|---|---|---|---|---|---|---|
| Ad | Head | Head | Size | Location | Type | CTA | Legal | Metric |
| 1 | A | C | E | G | J | M | P | 1.1% |
| 2 | A | D | F | H | K | O | P | 1.2% |
| 3 | A | C | F | L | J | M | P | 8.4% |
| 4 | A | D | E | H | K | N | R | 0.9% |
| 5 | A | C | E | L | K | O | R | 0.7% |
| 6 | A | D | F | G | J | N | R | 1.3% |
| 7 | B | C | F | L | K | O | P | 6.0% |
| 8 | B | D | E | G | J | N | P | 0.6% |
| 9 | B | C | E | L | K | M | P | 6.3% |
| 10 | B | D | F | G | J | O | R | 1.1% |
| 11 | B | C | F | L | K | M | R | 8.7% |
| 12 | B | D | E | H | K | N | R | 0.9% |

The nine columns of the table indicate, from left to right: (1) Advertisement serial number or identifier; (2) Headline; (3) Sub-Headline or secondary headline; (4) logo size; (5) logo location; (6) image type; (7) Call-to-Action (CTA) type (8) legal content; (9) the respective CTR (or other performance metric) of that particular advertisement.

For example: headline “A” may be “Get a new phone for free!”, whereas headline “B” may be “It is time to upgrade your phone!”; sub-headline “C” may be “When you switch”, whereas sub-headline “D” may be “For new customers only”; logo size “E” may be “less than 25 percent of the ad size”, whereas logo size “F” may be “25 or more percent of the ad size”; logo location “G” may be “central third of the ad canvas”, whereas logo location “H” may be “top-third of the ad canvas”, whereas logo location “L” may be “lower third of the ad canvas”; call-to-action (CTA) of “M” may be “Click here now”, whereas CTA of “N” may be “Learn more”, whereas CTA of “0” may be “Buy now”; legal content of “P” may be “Some restrictions apply”, whereas legal content of “R” may be “Void where prohibited”; the CTR is shown as a demonstrative example for a metric, whereas in some embodiments, other metric(s) may be used and the copy elements may be automatically generated and/or newly-generated by the NLG unit rather than being selected from a pool or bank of pre-defined textual elements.

In accordance with the present invention, the AI unit of the system, utilizing Neural Network and/or Machine Learning and/or other algorithms, may detect that components C-F-L-M are associated with the two most-successful ads (highest CTR metric); and that components B-J are associated with the two next successful ads; such that a suitable candidate for automatic ad generation may be a combination of the components C-F-L-M, together with the new generation of components B-J, along with component P (rather than R) as P appears in 3 out of the 4 most successful ads. The above is only a simplified example; whereas the system of the present invention is capable of performing such detection across a data-set that may include hundreds or thousands of ads, broken down into dozens of parameters or ad-elements; and may use a Neural Network or a Machine Learning model in order to detect or extract the particular combinations or permutations of ad elements that are associated with the most-successful metric(s) and NLG generation of new text components as identified by the system.

Some embodiments of the present invention may be implemented by using hardware components, software components, a processor, a processing unit, a processing core, a controller, an Integrated Circuit (IC), a memory unit (e.g., RAM, Flash memory), a storage unit (e.g., Flash memory, hard disk drive (HDD), sold state drive (SSD), optical storage unit), an input unit (e.g., keyboard, keypad, touch-screen, microphone, mouse, touch-pad), an output unit (e.g., monitor, screen, audio speakers, touch-screen), wireless transceiver, Wi-Fi transceiver, cellular transceiver, power source (e.g., rechargeable battery; electric outlet), an Operating System (OS), drivers, applications or “apps”, and/or other suitable components.

In some implementations, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results or on appropriate cloud based platforms such as Microsoft Azure or Amazon Web Services (AWS) or other cloud-based platform.

Although portions of the discussion herein relate, for demonstrative purposes, to wired links and/or wired communications, some implementations are not limited in this regard, but rather, may utilize wired communication and/or wireless communication; may include one or more wired and/or wireless links; may utilize one or more components of wired communication and/or wireless communication; and/or may utilize one or more methods or protocols or standards of wireless communication.

Some implementations may utilize a special-purpose machine or a specific-purpose device that is not a generic computer, or may use a non-generic computer or a non-general computer or machine. Such system or device may utilize or may comprise one or more components or units or modules that are not part of a “generic computer” and that are not part of a “general purpose computer”, for example, cellular transceiver, cellular transmitter, cellular receiver, GPS unit, location-determining unit, accelerometer(s), gyroscope(s), device-orientation detectors or sensors, device-positioning detectors or sensors, or the like.

Some embodiments may be implemented as (or, by utilizing) a “cloud computing” service or server(s) or repository; or may be provided to customers, clients, subscribers, logged-in users, authorized users, or other types of users via a Web-based interface, and/or via a Web browser, and/or may be provided as a “Software as a Service” implementation. In some embodiments, an entirety of the system may be cloud-based, and may be accessed via a “thin” end-user device or terminal or Web browser.

Some embodiments of the present invention may provide a computerized or automatic or autonomous system comprising: (A) an Artificial Intelligence (AI) unit, configured to receive as input: (i) digital copies of previously-used advertisements of an entity, and (ii) data of previous performance results of said previously-used advertisements, and (iii) a representation of brand guidelines, and (iv) a representation of a creative brief indicating guidelines for generation of a new advertisement for said entity; and further configured to analyze said input and to generate a set of advertisement elements that comprises at least: (I) a logo, (II) a headline, (III) a sub-headline, (IV) a call-to-action, and (V) an image; wherein said set of advertisement elements is generated based on analysis of said input and detection that said advertisement elements correspond to previous performance results that are beyond a pre-defined threshold; and (B) an automatic advertisement generation unit, to generate said new advertisement by digitally placing said set of advertisement elements onto a canvas.

In some embodiments, the system comprises: a computer vision unit and an Optical Character Recognition (OCR) unit, to extract discrete advertisement elements from said previously-used advertisements; an advertisement elements database, to store therein said discrete advertisement elements; wherein said AI unit creates said set of advertisement elements by generating the individual text elements and/or selecting particular discrete advertisement elements from said advertisement elements database, wherein said selecting is performed based on past performance of combinations of advertisement elements in previous advertising campaigns of said entity.

In some embodiments, the system comprises: a text-element classifier unit, to determine (i) textual elements of previous advertisements, and (ii) type classification of each textual element of previous advertisements; an image-element classifier unit, to determine type classification of each image element of previous advertisements; a prior advertisements component determination unit, to store textual elements and image elements of previous advertisements of said entity, into an advertisement elements database, based on said type classification of each textual element and based on type classification of each image element, respectively.

In some embodiments, the prior advertisements component determination unit is to determine and to further store, in said advertisement elements database, absolute position or relative position of each textual element or image element, based on analysis of said previous advertisements of said entity; wherein said absolute position or relative position, of each textual element or image element, is taken into account by said AI unit for selecting or generating said set of advertisement elements for automatically constructing said new advertisement.

In some embodiments, the system may comprise, for example: a Creative Brief to Feature Vectors (CB-2-FV) converter, to convert each one of a set of previously-used creative briefs of said entity, into a set of feature vectors that are suitable for processing by a Machine Learning (ML) unit; a Machine Learning (ML) unit to generate, based on sets of feature vectors of previously-used creative briefs and their corresponding previously-used advertisements, one or more ML models for creating new ads that include automatically-generated elements and/or selected collection of previously-used advertisement elements having particular in-canvas locations and particular properties of size and color.

In some embodiments, the ML unit operates by taking into account past performance of selected combinations of advertisement elements in past advertising campaigns of said entity.

In some embodiments, the AI unit utilizes said one or more ML models to determine a particular generation, selection and combination of discrete ad elements, which corresponds to best past performance among the respective past performance metrics of multiple combinations of discrete ad elements.

In some embodiments, the AI unit is to generate insights with regard to preferred advertisement elements and their size and in-canvas location, based on ML analysis of performance data of previously-used advertisements of said entity versus various combinations of ad elements of said previously-used advertisements.

In some embodiments, the AI unit is to analyze the ad elements extracted from previously-used advertisements of said entity, with corresponding performance data of each previously-used advertisement; and to generate a first insight that indicates that previous advertisements that included a first particular combination of ad elements had performed above a first threshold value which corresponds to successful performance; and to generate a second insight that indicates that previous advertisements that included a second, different, particular combination of ad elements had performed below a second threshold value which corresponds to unsuccessful performance.

In some embodiments, the AI unit is to analyze the ad elements extracted from previously-used advertisements of said entity, with corresponding performance data of each previously-used advertisement; and to generate an insight that indicates that a particular type of ad element, when it appears in an advertisement of said entity at a particular in-canvas size, corresponds to successful performance of previously-used ads.

In some embodiments, the AI unit is to analyze the ad elements extracted from previously-used advertisements of said entity, with corresponding performance data of each previously-used advertisement; and to generate an insight that indicates that a particular combination of font size and font color of a specific ad element, when it appears in an advertisement of said entity, corresponds to successful performance of previously-used ads.

In some embodiments, the AI unit generates a set of textual elements for said new advertisements, via a Natural Language Generation (NLG) unit for phrase generation that is based on a set of Feature Vectors that are obtained from an inputted Creative Brief, by applying one or more Machine Learning (ML) models that describe relations between (i) Feature Vectors of past creative briefs and (ii) past performance of previously-used advertisements that correspond to said past creative briefs.

In some embodiments, the automatic advertisement generation unit is to apply a set of Brand Guidelines which dictate at least (i) a color scheme and (ii) font typography properties and (iii) required clearance spacing for one or more ad elements, which must be used in new advertisements generated automatically for said entity.

In some embodiments, the automatic advertisement generation unit comprises: a Permutations Generator to generate new ad elements and/or to select multiple combinations of ad elements from a database of discrete ad elements extracted from previously-used advertisements of said entity, by taking into account past performance metrics of each ad element and of various combinations of two-or-more ad elements; an Ad Components Resize and Modification Unit to perform resizing and modification of each selected ad element, in each permutation, by taking into account past performance metrics of each ad element and of various combinations of two-or-more ad elements; an Ad Component Placement and Arrangement Unit, to place and arrange the selected ad elements within said canvas, by taking into account past performance metrics of each ad element and of various combinations of two-or-more ad elements; a Natural Language Generator (NLG) to automatically generate relevant textual elements and textual phrases, based on (i) a particular Creative Brief, and (ii) historical performance data of previous advertisements of said entity.

In some embodiments, the AI unit comprises a Prior Ads Analyzer Unit which (i) analyzes previous advertisements used by said entity and their respective performance metrics, and (ii) detects a particular combination of ad elements that appeared across multiple previous advertisements and that are estimated be a contributing factor to successful performance of said multiple previous advertisements.

In some embodiments, said automatic advertisement generation unit comprises a real-time on-the-fly tailored ad constructor unit, to generate said new advertisement in real-time in response to a search query entered by a particular end-user, based on user-specific past performance metrics of advertisements of said entity that were previously presented to said end-user.

In some embodiments, said AI unit performs a continuous, iterative, automatic advertisement generation process in which: (a) a first new ad is generated automatically based on past performance of previous ads; (b) the first new ad is utilized by said entity, and performance data for the first new ad is tracked and collected; (c) subsequently, a second new ad is generated automatically based on past performance of previous ads including past performance of said first new ad; wherein the process continuous to iteratively generate new ads, wherein performance metrics of automatically-generated ads are further utilized in subsequent iterations for further new ad generation.

In some embodiments, said AI unit analyzes past performance of previously-used advertisements, and generates a new ad element based on said past performance, wherein a database of previously-used ad elements of said entity excludes said new ad element; wherein said automatic advertisement generation unit is to include said new ad element within a newly-generated advertisement for said entity.

In some embodiments, said AI unit analyzes past performance of previously-used advertisements, and utilizes a Natural Language Generation (NLG) unit to generate a new ad element based on said past performance, wherein a database of previously-used ad elements of said entity excludes said new ad element; wherein said automatic advertisement generation unit is to include said new ad element within a newly-generated advertisement for said entity.

In some embodiments, said AI unit analyzes past performance of previously-used advertisements, and generates a new spatial layout, wherein a database of previously-used ads of said entity excludes said new spatial layout; wherein said automatic advertisement generation unit is to utilize said new spatial layout for a newly-generated advertisement for said entity.

Some embodiments may provide a computerized method comprising, for example: (A) performing an Artificial Intelligence (AI) algorithm, which comprises: receiving as input: (i) digital copies of previously-used advertisements of an entity, and (ii) data of previous performance results of said previously-used advertisements, and (iii) a representation of brand guidelines, and (iv) a representation of a creative brief indicating guidelines for generation of a new advertisement for said entity; analyzing said input, and generating a set of advertisement elements that comprises at least: (I) a logo, (II) a headline, (III) a sub-headline, (IV) a call-to-action, and (V) an image; wherein said set of advertisement elements is generated based on analysis of said input and detection that said advertisement elements correspond to previous performance results that are beyond a pre-defined threshold; (B) automatically generating said new advertisement by digitally placing said set of advertisement elements onto a canvas; wherein the method is implemented by using at least a hardware processor.

Some embodiments may include a non-transitory storage medium or storage article having stored thereon instructions or code that, when executed by a machine or a hardware processor, cause such machine or hardware processor to perform a method as described.

Some implementations may utilize an automated method or automated process, or a machine-implemented method or process, or as a semi-automated or partially-automated method or process, or as a set of steps or operations which may be executed or performed by a computer or machine or system or other device.

Some implementations may utilize code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL), Register-Transfer Level (RTL), BASIC, Visual BASIC, Matlab, Pascal, HTML, HTML5, CSS, Perl, Python, PHP, machine language, machine code, assembly language, or the like.

Discussions herein utilizing terms such as, for example, “processing”, “computing”, “calculating”, “generating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some implementations may be used in, or in conjunction with, various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a tablet, an on-board device, an off-board device, a hybrid device, a vehicular device, a non-vehicular device, a mobile or portable device, a consumer device, a non-mobile or non-portable device, an appliance, a wireless communication station, a wireless communication device, a wireless Access Point (AP), a wired or wireless router or gateway or switch or hub, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), or the like.

Some implementations may be used in conjunction with one way and/or two-way radio communication systems, cellular radio-telephone communication systems, a mobile phone, a cellular telephone, a wireless telephone, a Personal Communication Systems (PCS) device, a PDA or handheld device which incorporates wireless communication capabilities, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some implementations may comprise, or may be implemented by using, an “app” or application which may be downloaded or obtained from an “app store” or “applications store”, for free or for a fee, or which may be pre-installed on a computing device or electronic device, or which may be otherwise transported to and/or installed on such computing device or electronic device. The implementation may also comprise a plug-in or extension or add-on or a software patch or a software update or a software modification to an existing design software (such as Adobe Photoshop) or to a workflow software (such as Workfront), to allow users to efficiently and rapidly access the system of the present without leaving their operational environment and/or from within such software or application, and to allow.

Functions, operations, components and/or features described herein with reference to one or more implementations, may be combined with, or may be utilized in combination with, one or more other functions, operations, components and/or features described herein with reference to one or more other implementations. Some embodiments may comprise any possible or suitable combinations, re-arrangements, assembly, re-assembly, or other utilization of some or all of the modules or functions or components or units that are described herein, even if they are discussed in different locations or different chapters of the above discussion, or even if they are shown across different drawings or multiple drawings.

While certain features of some demonstrative embodiments have been illustrated and described herein, various modifications, substitutions, changes, and equivalents may occur to those skilled in the art. Accordingly, the claims are intended to cover all such modifications, substitutions, changes, and equivalents.

What is claimed is:

1. A system comprising:
(A) an Artificial Intelligence (AI) unit,
configured to receive as input: (i) digital copies of previously-used advertisements of an entity, and (ii) data of previous performance results of said previously-used advertisements, and (iii) a representation of brand guidelines, and (iv) a representation of a creative brief indicating guidelines for generation of a new advertisement for said entity;
further configured to analyze said input and to generate a set of advertisement elements that comprises at least: (I) a logo, (II) a headline, (III) a sub-headline, (IV) a call-to-action, and (V) an image,
wherein said set of advertisement elements is generated based on analysis of said input and detection that said advertisement elements correspond to previous performance results that are beyond a pre-defined threshold;
(B) an automatic advertisement generation unit, to generate said new advertisement by digitally placing said set of advertisement elements onto a canvas.

2. The system of claim 1, comprising:
a computer vision unit and an Optical Character Recognition (OCR) unit, to extract discrete advertisement elements from said previously-used advertisements;
an advertisement elements database, to store therein said discrete advertisement elements;
wherein said AI unit creates said set of advertisement elements by generating the individual text elements and/or selecting particular discrete advertisement elements from said advertisement elements database, wherein said selecting is performed based on past performance of combinations of advertisement elements in previous advertising campaigns of said entity.

3. The system of claim 1, comprising:
a text-element classifier unit, to determine (i) textual elements of previous advertisements, and (ii) type classification of each textual element of previous advertisements;
an image-element classifier unit, to determine type classification of each image element of previous advertisements;
a prior advertisements component determination unit, to store textual elements and image elements of previous advertisements of said entity, into an advertisement elements database, based on said type classification of each textual element and based on type classification of each image element, respectively.

4. The system of claim 3,
wherein the prior advertisements component determination unit is to determine and to further store, in said advertisement elements database, absolute position or relative position of each textual element or image element, based on analysis of said previous advertisements of said entity;
wherein said absolute position or relative position, of each textual element or image element, is taken into account by said AI unit for selecting or generating said set of advertisement elements for automatically constructing said new advertisement.

5. The system of claim 1, comprising:
a Creative Brief to Feature Vectors (CB-2-FV) converter, to convert each one of a set of previously-used creative briefs of said entity, into a set of feature vectors that are suitable for processing by a Machine Learning (ML) unit;
a Machine Learning (ML) unit to generate, based on sets of feature vectors of previously-used creative briefs and their corresponding previously-used advertisements, one or more ML models for creating new ads that include automatically-generated elements and/or selected collection of previously-used advertisement elements having particular in-canvas locations and particular properties of size and color.

6. The system of claim 5,
wherein the ML unit operates by taking into account past performance of selected combinations of advertisement elements in past advertising campaigns of said entity.

7. The system of claim 5,
wherein the AI unit utilizes said one or more ML models to determine a particular generation, selection and combination of discrete ad elements, which corresponds to best past performance among the respective past performance metrics of multiple combinations of discrete ad elements.

8. The system of claim 5,
wherein the AI unit is to generate insights with regard to preferred advertisement elements and their size and in-canvas location, based on ML analysis of performance data of previously-used advertisements of said entity versus various combinations of ad elements of said previously-used advertisements.

9. The system of claim 1,
wherein the AI unit is to analyze the ad elements extracted from previously-used advertisements of said entity, with corresponding performance data of each previously-used advertisement; and to generate a first insight that indicates that previous advertisements that included a first particular combination of ad elements had performed above a first threshold value which corresponds to successful performance; and to generate a second insight that indicates that previous advertisements that included a second, different, particular combination of ad elements had performed below a second threshold value which corresponds to unsuccessful performance.

10. The system of claim 1,
wherein the AI unit is to analyze the ad elements extracted from previously-used advertisements of said entity, with corresponding performance data of each previously-used advertisement; and to generate an insight that indicates that a particular type of ad element, when it appears in an advertisement of said entity at a particular in-canvas size, corresponds to successful performance of previously-used ads.

11. The system of claim 1,
wherein the AI unit is to analyze the ad elements extracted from previously-used advertisements of said entity, with corresponding performance data of each previously-used advertisement; and to generate an insight that indicates that a particular combination of font size and font color of a specific ad element, when it appears in an advertisement of said entity, corresponds to successful performance of previously-used ads.

12. The system of claim 1,
wherein the AI unit generates a set of textual elements for said new advertisements, via a Natural Language Generation (NLG) unit for phrase generation that is based on a set of Feature Vectors that are obtained from an inputted Creative Brief, by applying one or more Machine Learning (ML) models that describe relations between (i) Feature Vectors of past creative briefs and (ii) past performance of previously-used advertisements that correspond to said past creative briefs.

13. The system of claim 12,
wherein the automatic advertisement generation unit is to apply a set of Brand Guidelines which dictate at least (i) a color scheme and (ii) font typography properties and (iii) required clearance spacing for one or more ad elements, which must be used in new advertisements generated automatically for said entity.

14. The system of claim 1,
wherein the automatic advertisement generation unit comprises:
a Permutations Generator to generate new ad elements and/or to select multiple combinations of ad elements from a database of discrete ad elements extracted from previously-used advertisements of said entity, by taking into account past performance metrics of each ad element and of various combinations of two-or-more ad elements;
an Ad Components Resize and Modification Unit to perform resizing and modification of each selected ad element, in each permutation, by taking into account past performance metrics of each ad element and of various combinations of two-or-more ad elements;
an Ad Component Placement and Arrangement Unit, to place and arrange the selected ad elements within said canvas, by taking into account past performance metrics of each ad element and of various combinations of two-or-more ad elements;
a Natural Language Generator (NLG) to automatically generate relevant textual elements and textual phrases, based on (i) a particular Creative Brief, and (ii) historical performance data of previous advertisements of said entity.

15. The system of claim 1,
wherein the AI unit comprises a Prior Ads Analyzer Unit which (i) analyzes previous advertisements used by said entity and their respective performance metrics, and (ii) detects a particular combination of ad elements that appeared across multiple previous advertisements and that are estimated be a contributing factor to successful performance of said multiple previous advertisements.

16. The system of claim 1,
wherein said automatic advertisement generation unit comprises a real-time on-the-fly tailored ad constructor unit, to generate said new advertisement in real-time in response to a search query entered by a particular end-user, based on user-specific past performance metrics of advertisements of said entity that were previously presented to said end-user.

17. The system of claim 1,
wherein said AI unit performs a continuous, iterative, automatic advertisement generation process in which: (a) a first new ad is generated automatically based on past performance of previous ads; (b) the first new ad is utilized by said entity, and performance data for the first new ad is tracked and collected; (c) subsequently, a second new ad is generated automatically based on past performance of previous ads including past performance of said first new ad; wherein the process continuous to iteratively generate new ads, wherein performance metrics of automatically-generated ads are further utilized in subsequent iterations for further new ad generation.

18. The system of claim 1,
wherein said AI unit analyzes past performance of previously-used advertisements, and generates a new ad element based on said past performance, wherein a database of previously-used ad elements of said entity excludes said new ad element;
wherein said automatic advertisement generation unit is to include said new ad element within a newly-generated advertisement for said entity.

19. The system of claim 1,
wherein said AI unit analyzes past performance of previously-used advertisements, and utilizes a Natural Language Generation (NLG) unit to generate a new ad element based on said past performance, wherein a database of previously-used ad elements of said entity excludes said new ad element;
wherein said automatic advertisement generation unit is to include said new ad element within a newly-generated advertisement for said entity.

20. The system of claim 1,
wherein said AI unit analyzes past performance of previously-used advertisements, and generates a new spatial layout, wherein a database of previously-used ads of said entity excludes said new spatial layout;
wherein said automatic advertisement generation unit is to utilize said new spatial layout for a newly-generated advertisement for said entity.

21. A computerized method comprising:
(A) performing an Artificial Intelligence (AI) algorithm, which comprises:
receiving as input: (i) digital copies of previously-used advertisements of an entity, and (ii) data of previous performance results of said previously-used advertisements, and (iii) a representation of brand guidelines, and (iv) a representation of a creative brief indicating guidelines for generation of a new advertisement for said entity;
analyzing said input, and generating a set of advertisement elements that comprises at least: (I) a logo, (II) a headline, (III) a sub-headline, (IV) a call-to-action, and (V) an image,
wherein said set of advertisement elements is generated based on analysis of said input and detection that said advertisement elements correspond to previous performance results that are beyond a pre-defined threshold;
(B) automatically generating said new advertisement by digitally placing said set of advertisement elements onto a canvas;
wherein the method is implemented by using at least a hardware processor.
